(19) United States
(12) Patent Application Publication
(10) Pub. No.: US 2006/0062554 A1
(43) Pub. Date: Mar. 23, 2006

(54) Picture viewer

(76) Inventor: Jay A. Jupiter, Alexandria, VA (US)

Correspondence Address: STEPTOE & JOHNSON LLP, 1330 CONNECTICUT AVENUE, N.W., WASHINGTON, DC, 20036, US

(21) Appl. No.: 10/668,188

(22) Filed: Sep. 24, 2003

(51) Int. Cl. H04N 5/781

(52) U.S. Cl. 386/125; 386/126

(57) ABSTRACT

A portable digital image viewer reads digital image files from a CD-ROM and displays them on a screen.

### TECHNICAL FIELD

This invention relates to a device for viewing digital images.

### BACKGROUND

Digital cameras are becoming very popular. The quality of images recorded by digital cameras is indistinguishable from photos taken on traditional film to the average user. There are no expenses associated with film or film processing. Unlike prints or slides, digital images do not degrade over time. Generally, sharing digital photos with family and friends is simple and inexpensive, e.g. by posting them on the internet or sending them by e-mail. Sharing the images can be difficult, however, if the user wants to share his or her digital images with someone who does not have reliable access to the internet or is uncomfortable with computers. Making and sending prints of digital images can be expensive. Furthermore, sharing digital images with groups of people together can be awkward. Typically the images are displayed on a computer monitor, which in most homes is on a table or desk and is not intended to be viewed by a group.

### BRIEF DESCRIPTION OF THE DRAWING

FIG. 1. is a top view of a portable picture viewer.

### SUMMARY

A portable digital viewer can display images recorded on a CD-ROM. The viewer can be handheld and simple for a user to operate. The viewer can be easily viewed by several people at once, or passed among a group people, for example at a family gathering. Users can view digital images without a computer or internet access. The display screen on which images appear can be larger than a screen found on a digital camera. The user can zoom and pan the images. Because CD player technology is now very affordable, the viewer can be inexpensive.

In one aspect, a portable digital image viewer includes a CD-ROM reader configured to read a digital image file from a CD-ROM and an integrated display screen configured to display the digital image file.

In another aspect, a portable digital image viewer includes a CD-ROM reader configured to read a digital image file from a CD-ROM, an input for a digital memory card configured to read a digital image file from a digital memory card, and an integrated display screen configured to display a digital image.

The viewer can include a base including the CD-ROM reader. The viewer can include a lid including the integrated display screen, the lid being attached to the base by a hinge and swinging between an open position and a closed position, wherein the lid when in the closed position encloses the CD-ROM and exposes the integrated display screen. The viewer can include one or more control keys mounted on the base or on the lid and operably connected to the CD-ROM reader. The integrated display screen can be a color LCD. The color LCD can have a diagonal of no more than 6 inches. The CD-ROM reader can include a laser that operates at a wavelength longer than 750 nm. The viewer can be configured to display one or more images on the integrated display screen as a thumbnail. The viewer can be configured to display a digital image at full size on the integrated display screen.

The details of one or more embodiments are set forth in the description below. Other features, objects, and advantages will be apparent from the description, and from the claims.

### DETAILED DESCRIPTION

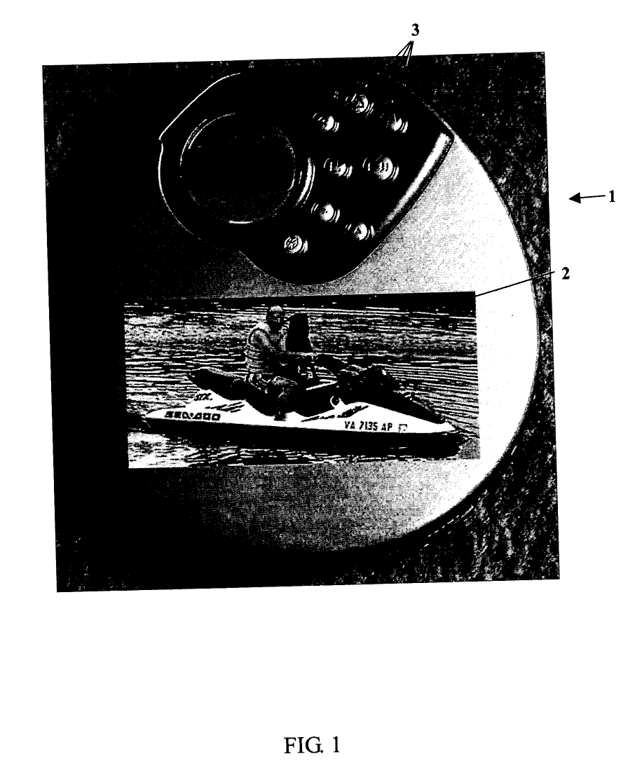

Referring to FIG. 1, a portable picture viewer 1 displays digital images stored on a CD-ROM. The viewer includes a CD-ROM drive capable of reading data from a CD-ROM. The viewer includes an integrated display screen 2, such as a flat liquid crystal display (LCD) for displaying the images. The display screen can be a full color, high resolution screen. Color LCDs are available in a wide range of sizes, having diagonal dimensions as small as 1 inch to greater than 15 inches. The viewer desirably has a screen similar in size to the CD-ROM. A portable CD-ROM has a diameter of 12 cm. The screen can have a diagonal dimension of, for example, less than 20 cm or less than 15 cm. The viewer can be battery powered, and can optionally include a jack for connecting to an external power supply. The portable viewer can be handheld, in other words, of a size and weight that is easily carried in one hand. The operation of the viewer is straightforward to the user.

The viewer can show image files of any digital image file format, such as for example, joint photographic experts group (JPEG) format, tagged image file format (TIFF), graphics interchange format (GIF), or bitmap. The image files can be produced by digital camera, by scanning an image from paper or film, or any other method of producing a digital image file. The CD-ROM can be prepared by a user by, for example, using a personal computer (PC) with a CD-ROM drive to record the user's digital photograph files on a CD-ROM. The CD-ROM can be prepared by a commercial service that develops photographic film and converts the photographs to digital image files.

The viewer can have a base that includes the CD-ROM drive. The drive includes a spindle upon which a CD-ROM is loaded. The spindle is attached to a motor for spinning the CD-ROM for data retrieval from the CD-ROM. The base can have a lid that covers the CD-ROM during operation of the viewer. The lid is opened to allow loading and removal of a CD-ROM. The integrated display screen can be mounted on the lid of the viewer. The viewer includes keys or buttons 3 for controlling the operation of the viewer. The keys or buttons can be mounted on the lid, for example.

The viewer can include additional hardware and software to connect to a PC. Once connected to a PC, digital images can be transferred to or from the CD-ROM in the viewer. The viewer can include inputs for other digital storage formats, for example memory cards. Examples of digital memory cards include SmartMedia, CompactFlash, Secure Digital, and Memory Stick. Many digital cameras record images directly to a memory card. A user can take pictures on a digital camera, then transfer the memory card to the viewer to view the pictures. The viewer can be configured to play digital video using standard formats (e.g. MPEG or Quicktime) for example, movie clips created by a digital camera or camcorder and stored on a CD-ROM. The viewer can include a speaker or headphone jack for reproducing the audio portion of a video file.

A CD-ROM having image files stored on it is loaded on the spindle and the lid is closed. A controller controls the motor to read the data out of the CD-ROM. The controller scans the CD-ROM and detects the presence of image files. The controller temporarily stores the data in the data buffer area of the internal memory, and then transfers the data to a video decoder. Upon receipt of the data from the controller the video decoder extracts and decodes the data from the controller, and outputs the data to the display.

A list of file names can be presented to the user on the display screen. Alternatively, the image files are presented on the display screen as thumbnail images, i.e. the images are presented together simultaneously on the display screen, each image occupying a fraction of the total area of the screen. The viewer can recognize if the image files are stored in a directory or tree structure, and present a list of directories or folders to the user. One or more images can be selected. A selection can be indicated by, for example, a border or box around the thumbnail or file name, or a difference in color or shading of the thumbnail or file name. Using the control buttons the user can choose which image or images are selected. The selected images can then be displayed full-size, i.e. such that the image occupies the full area of the display screen.

The selected images can be displayed one at a time, remaining on the display screen until a user command, or can advance automatically to the next selected image. The user can determine the length of time that each image is displayed, or pause the display on a particular image. The image can be zoomed in or out to show a portion of the image in greater or lesser detail. The user can pan the image, thereby controlling the region of the image that is presented on the display screen. The control buttons can allow the user to execute forward, backward and select commands for selecting images. The buttons that execute the forward and backward commands can also be used in a zoom in or zoom out command, or to move between to the selected images. Other buttons can control start, stop, pause, and resume operations.

The CD-ROM drive includes an optical pickup for reading the signal encoded on the CD-ROM. A signal amplifier amplifies the signal read by the optical pickup. The amplified signal from the amplifier is fed into a programmable digital signal processor (DSP). DSPs are readily available from a large number of sources, one example being the Butterfly DSP from SHARP Microelectronics, 5700 NW Pacific Rim Blvd., Camas, Wash. 98607. A decoding software program directs the operation of the DSP. This decoding software program is stored in a memory. The memory is preferably a nonvolatile memory, which retains its contents in the absence of external power and is readable and writeable.

A typical CD-ROM drive includes a laser operating in the infrared, e.g. at a wavelength of 780 nm, as part of the optical pickup. The CD-ROM itself stores data as pits in a metal surface, encased in a protective transparent plastic. The minimum size of a pit on a CD-ROM is 0.83 micrometers, and the track pitch, i.e. the distance between adjacent rows of pits, is 1.6 micrometers. By comparison, the laser in a DVD drive works at a shorter wavelength (e.g., 635 or 650 nm). The DVD has a smaller minimum pit size of 0.4 micrometers, and a narrower track pitch of 0.74 micrometers. See, for example, “DVD Tutorial—Introduction”, presented at http://www.dsi.unive.it/˜smm/2001/docs/cruce98/introduction.html, Sep. 11, 2003, which is incorporated by reference in its entirety.

A number of embodiments have been described. Nevertheless, it will be understood that various modifications may be made. Accordingly, other embodiments are within the scope of the following claims.

What is claimed is:

1. A portable digital image viewer comprising:
a compact disc reader configured to read a digital image file from a compact disc; and
an integrated display screen configured to display a still image from the digital image file.

2. The viewer of claim 1, further comprising a base including the compact disc reader.

3. The viewer of claim 2, further comprising a lid including the integrated display screen, the lid being attached to the base by a hinge and swinging between an open position and a closed position, wherein the lid encloses a compact disc.

4. The viewer of claim 3, further comprising one or more control keys mounted on the base or on the lid and operably connected to the compact disc reader.

5. The viewer of claim 4, wherein a control key is configured to advance a first still image displayed on the screen to a second still image.

6. The viewer of claim 1, wherein the integrated display screen is a color screen.

7. The viewer of claim 6, wherein the color screen has a diagonal dimension of no more than 6 inches.

8. The viewer of claim 1, wherein the compact disc reader includes a laser that operates at a wavelength longer than 750 nm.

9. The viewer of claim 1, further comprising a controller, wherein the digital image file is a JPEG, GIF, TIFF or bitmap file and the controller is configured to decode the digital image file for display on the integrated display screen.

10. A portable digital image viewer comprising:
a compact disc reader configured to read a digital image file from a compact disc, wherein the compact disc reader includes a laser that operates at a wavelength longer than 750 nm; and
an integrated display screen configured to display a still image from the digital image file.

11. The viewer of claim 10, further comprising a base including the compact disc reader.

12. The viewer of claim 11, further comprising a lid including the integrated display screen, the lid being attached to the base by a hinge and swinging between an open position and a closed position, wherein the lid when in the closed position encloses the compact disc.

13. The viewer of claim 10, further comprising one or more control keys mounted on the base or on the lid and operably connected to the compact disc reader.

14. The viewer of claim 10, wherein the viewer is configured to display one or more images on the integrated display screen as a thumbnail.

15. The viewer of claim 10, wherein the viewer is configured to display a digital image at full size on the integrated display screen.

16. A portable digital image viewer comprising:
a compact disc reader configured to read a digital image file from a compact disc;
an input port for a digital memory card configured to read a digital image file from a digital memory card; and
an integrated display screen configured to display a still image from the digital image file.

17. The viewer of claim 16, further comprising a base including the compact disc reader.

18. The viewer of claim 17, further comprising a lid including the integrated display screen, the lid being attached to the base by a hinge and swinging between an open position and a closed position, wherein the lid when in the closed position encloses the compact disc.

19. The viewer of claim 16, further comprising one or more control keys mounted on the base or on the lid and operably connected to the compact disc reader.

20. The viewer of claim 16, wherein the viewer is configured to display one or more still images generated from one or more digital image files on the compact disc on the integrated display screen as a thumbnail.

21. The viewer of claim 16, wherein the viewer is configured to display a still image generated from a digital image file on the compact disc at full size on the integrated display screen.

22. The viewer of claim 16, wherein the compact disc reader includes a laser that operates at a wavelength longer than 750 nm.
